(19) United States
(12) Patent Application Publication
(10) Pub. No.: US 2011/0175772 A1
(43) Pub. Date: Jul. 21, 2011

(54) POSITIONING DEVICE, POSITIONING METHOD AND STORAGE MEDIUM

(75) Inventor: Masao Sambongi, Hachioji-shi (JP)

(73) Assignee: CASIO COMPUTER CO., LTD., Tokyo (JP)

(21) Appl. No.: 12/971,344

(22) Filed: Dec. 17, 2010

(30) Foreign Application Priority Data
Jan. 15, 2010 (JP) 2010-006561
Oct. 22, 2010 (JP) 2010-236963

(51) Int. Cl. G01S 19/47; G01S 19/34

(52) U.S. Cl. 342/357.3; 342/357.74

(57) ABSTRACT

When a positioning request is made, position measurement using a positioning satellite is executed, and when the position measurement is executed, positioning result data is obtained as position data responded to the positioning request. On the other hand, when the position measurement using the positioning satellite is not executed, position measurement result data based on the measurement of a moving direction and a moving amount is obtained as position data responded to the positioning request.

### CROSS-REFERENCE TO RELATED APPLICATIONS

This application is based upon and claims the benefit of priority from the prior Japanese Patent Application No. 2010-6561, filed on Jan. 15, 2010 and the prior Japanese Patent Application No. 2010-236963, filed on Oct. 22, 2010, and the entire contents of which are incorporated herein by reference.

### BACKGROUND OF THE INVENTION

1. Field of the Invention

The present invention relates to a positioning device for receiving a signal from a positioning satellite to perform position measurement, a positioning method and a storage medium.

2. Description of Related Art

It is known that position measurement is intermittently performed every predetermined period or position measurement is performed interlockingly with a specific operation such as a camera imaging operation or the like in some electronic equipment having a GPS (Global Positioning System) function (see JP-A-2002-267734, JP-A-2006-339723 and U.S. Pat. No. 6,995,792, for example).

Furthermore, in order to quickly perform position measurement, GPS positioning devices generally adopt a construction that ephemeris information of each GPS satellite which was received in previous positioning processing is stored in a memory and positioning calculation is performed by using this ephemeris information when subsequent positioning processing is executed, so that present position data can be obtained at short times.

In some cases, even the GPS positioning devices which can perform positioning measurement at short times cannot obtain position data because a processing time elapses under a state that the positioning processing is not completed, for example when an execution time consumable for the positioning processing is limited to a remarkably short time, when the number of GPS satellites whose radio waves can be acquired is reduced at a valley between buildings or the like, when the electrical field intensity of radio waves is remarkably weakened, etc.

### SUMMARY OF THE INVENTION

An object of the present invention is to provide a positioning device, a positioning method and a storage medium storing a program in which position data does not lack even when a positioning measurement using positioning satellites cannot be properly executed in a process of obtaining position data in response to a positioning request.

In order to attain the above object, there is provided a positioning device according to the present invention comprising: a receiver for receiving a signal from a positioning satellite; first positioning means for performing position measurement on the basis of a signal of the positioning satellite received through the receiver; second positioning means for measuring a moving direction and a moving amount and accumulating a moving vector comprising the moving direction and the moving amount to perform relative position measurement; an operating unit for accepting an operation input from an external; and a measurement controller for making the second positioning means execute position measurement continually and making the first positioning means execute position measurement under a predetermined condition, wherein the measurement controller makes the first positioning means execute the position measurement when a positioning request is made through the operating unit, and the measurement controller obtains positioning result data of the first positioning means as position data responded to the positioning request when position measurement of the first positioning means is performed, and obtains positioning result data of the second positioning means as position data responded to the positioning request when position measurement of the first positioning means is not performed.

Furthermore, according to the present invention, there is provided a positioning method for performing position measurement by using a receiver for receiving a signal from a positioning satellite, first positioning means that can perform position measurement on the basis of a signal of the positioning satellite received through the receiver, and second positioning means that can measure a moving direction and a moving amount and accumulate a moving vector comprising the moving direction and the moving amount to perform relative position measurement comprising: a first measurement control step for making the first positioning means execute position measurement in response to a positioning request; a second measurement control step for making the second positioning means execute position measurement continually; and a position data obtaining step for obtaining measurement result data of the first measurement control step as position data responded to the positioning request when position measurement in the first measurement control step is performed and obtaining measurement result data of the second measurement control step as position data responded to the positioning request when position measurement in the first measurement control step is not performed.

Still furthermore, according to the present invention, there is provided a storage medium readable by a computer that controls a receiver for receiving a signal from a positioning satellite, first positioning means that can perform position measurement on the basis of a signal of the positioning satellite received through the receiver, and second positioning means that can measure a moving direction and a moving amount and accumulate a moving vector comprising the moving direction and the moving amount to perform relative position measurement, the storage medium storing a program making the computer execute: a first measurement control function of making the first positioning means execute position measurement in response to a positioning request; a second measurement control function of making the second positioning means execute position measurement continually; and a position data obtaining function of obtaining measurement result data of the first measurement control function as position data responded to the positioning request when position measurement in the first measurement control function is performed and obtaining measurement result data of the second measurement control function as position data responded to the positioning request when position measurement in the first measurement control function is not performed.

### BRIEF DESCRIPTION OF THE DRAWINGS

FIG. 1 is a block diagram showing the whole of electronic equipment according to an embodiment of the present invention;

FIG. 2 is a diagram showing an example of the operation of positioning control processing executed by the electronic equipment of FIG. 1;

FIG. 3 shows a first part of a flowchart representing the procedure of the positioning control processing executed by sub CPU;

FIG. 4 shows a second part of the flowchart showing the procedure of the positioning control processing;

FIG. 5 shows a third part of the flowchart showing the procedure of the positioning control processing;

FIG. 6 shows a fourth part of the flowchart showing the procedure of the positioning control processing; and

FIG. 7 shows a fifth part of the flowchart showing the procedure of the positioning control processing.

### DETAILED DESCRIPTION OF THE PREFERRED EMBODIMENT

An embodiment of the present invention will be described hereunder with reference to the drawings.

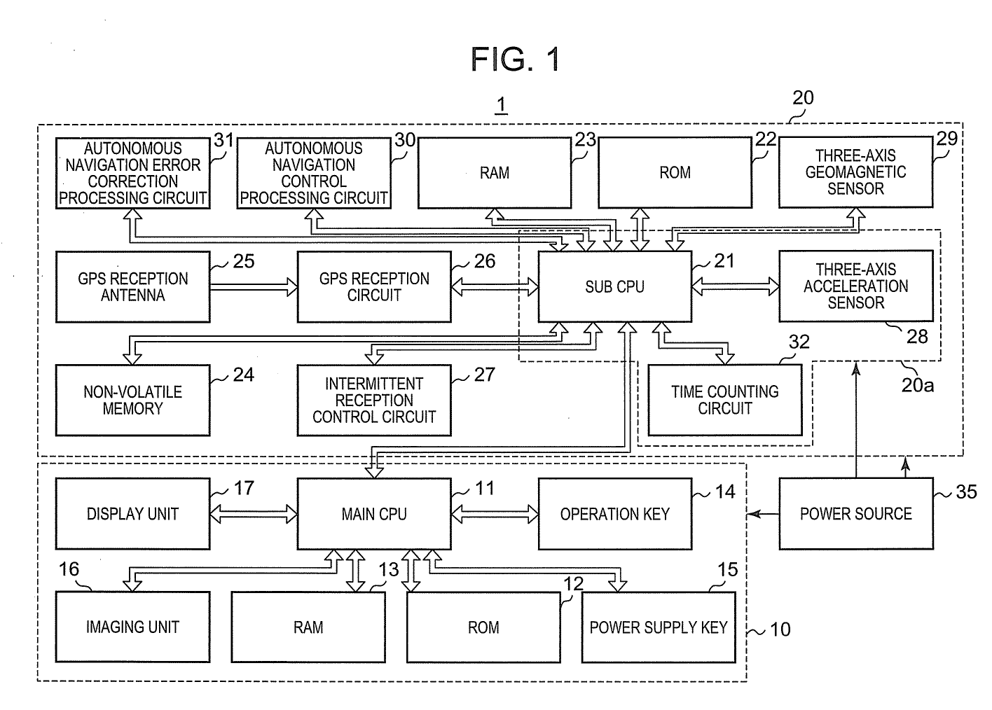

FIG. 1 is a block diagram showing the whole of electronic equipment of an embodiment according to a positioning device of the present invention.

The electronic equipment 1 of this embodiment is a device that has an imaging function for electrically picking up an image and saving the pickup image as image data and a positioning function based on GPS (Global Positioning System) or autonomous navigation, and can store the image data obtained through the imaging function and the position data obtained through the positioning function while associating them with each other.

As shown in FIG. 1, the electronic equipment 1 has a first processor 10 for executing the processing concerning the imaging function and a user interface function, a second processor 20 for executing the processing concerning the positioning function, a power source 35 for supplying a power supply voltage to each part, etc.

The first processor 1 has main CPU (central processing circuit) 11 for executing arithmetic processing, ROM (Read Only Memory) 12 in which a control program to be executed by the main CPU 11 and control data are stored, RAM (Random Access Memory) 13 for supplying the main CPU 11 with a working memory space, an operation key 14 for inputting a command from the external, a power supply key 15 for inputting a power supply switching operation, an imaging unit 16 for performing an image pickup operation by using an imaging element such as CCD (Charge Coupled Device) or the like, a display unit 17 such as a liquid crystal display or the like for displaying various kinds of information, etc.

The second processor 20 has sub CPU 21 for executing arithmetic processing, ROM 22 in which a control program to be executed by the sub CPU 21 and control data are stored, RAM 23 for supplying the sub CPU 21 with a working memory space, a non-volatile memory 24 for storing the control data, a GPS reception antenna 25 for receiving radio waves transmitted from a GPS satellite, a GPS reception circuit 26 for capturing and demodulating a transmission signal of the GPS satellite, an intermittent reception control circuit 27 for performing control concerning intermittent reception of ephemeris information, a three-axis acceleration sensor 28 for detecting accelerations in three axial directions, a three-axis geomagnetic sensor 29 for detecting the magnitude of earth's magnetism in the three-axial directions, an autonomous navigation control processing circuit 30 for obtaining present position data by autonomous navigation on the basis of outputs of the three-axis acceleration sensor 28 and the three-axis geomagnetic sensor 29, an autonomous navigation error correction processing circuit 31 for correcting the position data obtained by the autonomous navigation when position measurement based on GPS is executed, a time counting circuit 32 for counting the time, etc.

In the electronic equipment 1 of this embodiment, a switching operation of three routes is executed with respect to power supply from the power source 35 to each part. In the first processor 10, power supply and power interruption are switched to each other by operating the power supply key 15, whereby the first processor 10 is switched between a working state and a stopped state.

A full-time working unit 20a of the second processor 20 is always set to a power-supplied state. The full-time working unit 20a contains the sub CPU 21, the time counting circuit 32 and the three-axis acceleration sensor 28. With respect to the other parts of the second processor 20, the power supply state is switched under the control of the sub CPU 21. That is, the operation mode of the sub CPU 21 is switched on the basis of the operation state of the first processor 10 and the output of the three-axis acceleration sensor 28 so that the sub CPU 21 is set to a sleep state or a start-up state. When the sub CPU 21 is under the start-up state, it continues the power supply to the overall second processor 20, however, when the sub CPU 21 is under the sleep state, it stops power supply to the parts other than the full-time working unit 20a.

The GPS reception circuit 26 performs inverse-spreading processing by using a predetermined spreading code while establishing synchronization of the processing timing with a plurality of GPS satellites, whereby a transmission radio wave of each GPS satellite which is subjected to spread spectrum is acquired and demodulated.

The intermittent reception control circuit 27 performs control on the basis of a reception command of ephemeris information issued intermittently from the sub CPU 21 so that necessary ephemeris information is received through the GPS reception circuit 26. Specifically, when the reception command is received, demodulation data sent from the GPS reception circuit 26 is input, and it is monitored whether necessary ephemeris information is received or not. When ephemeris information of a necessary number of GPS satellites is received, completion of the reception is notified to the sub CPU 21.

In the non-volatile memory 24 are stored a plurality of position data as a positioning measurement result of GPS and the autonomous navigation, and also ephemeris information of plural GPS satellites which are intermittently received.

In addition to the generalized control processing of the second processor 20, the sub CPU 21 actuates the GPS reception circuit 26 and performs predetermined positioning calculation, whereby the processing of calculating the present position of the electronic equipment 1 is also executed. In the positioning calculation, the sub CPU 21 calculates a pseudo-distance to each GPS satellite on the basis of positioning codes transmitted from plural GPS satellites, calculates the position of each GPS satellite on the basis of the ephemeris information stored in the non-volatile memory 24, and calculates the position of the sub CPU 21 itself on the basis of these calculation results.

The three-axis acceleration sensor 28 has both of a function as an autonomous navigation sensor for performing the position measurement based on the autonomous navigation and a function as motion detector for detecting whether the electronic equipment 1 is under a used state or not.

That is, as the function of the autonomous navigation sensor, the three-axis acceleration sensor 28 measures the gravitational direction for specifying the orientation of the electronic equipment 1 and measures the acceleration variation in the gravitational direction to determine a walking motion (the number of steps) of a user carrying the electronic equipment 1. Furthermore, in order to specify the walking direction of the user carrying the electronic equipment 1, the three-axis acceleration sensor 28 measures the acceleration variation in the front-and-rear and right-and-left directions which are caused by the walking motion.

As the function of the motion detector, the three-axis acceleration sensor 28 determines whether the acceleration variation of a fixed level or more does not occur for a fixed time (for example, 30 seconds or one minute) or more, and outputs a start-up control signal based on this determination to a start-up terminal of the sub CPU 21. When there is an acceleration variation of a fixed level or more, the start-up control signal is set as an active level, and when the acceleration variation of a fixed level or more does not occur for a fixed time or more, the start-up control signal is set to an inactive level. By controlling the start-up terminal with the three-axis acceleration sensor 28, the sub CPU 21 is switched between the start-up state and the sleep state under the state that the power of the electronic equipment 1 is turned off.

The three-axis geomagnetic sensor 29 measures the direction of the magnetic north to specify the orientation of the electronic equipment 1 when the positioning measurement based on the autonomous navigation is executed.

The autonomous navigation control processing circuit 30 is an arithmetic circuit for assisting the arithmetic processing of the sub CPU 21, and it input the measurement data of the three-axis geomagnetic sensor 29 and the three-axis acceleration sensor 28 through the sub CPU 21 at a predetermined sampling period, and calculates the moving direction and the moving amount of the electronic equipment 1 from these measurement data. Specifically, the number of steps of the user carrying the electronic equipment 1 is counted on the basis of the measurement result of the acceleration variation in the up-and-down direction which is obtained by the three-axis acceleration sensor 28, and multiplies the counted step number by stride data which is preset, thereby determining a relative moving amount. Furthermore, the orientation of the electronic equipment 1 is determined on the basis of the measurement result of the gravitational direction of the three-axis acceleration sensor 28 and the measurement result of the magnetic north direction of the three-axis geomagnetic sensor 29, and determines the walking direction (that is, the moving direction) of the user carrying the electronic equipment 1 on the basis of the detection results of great swinging in the front-and-rear direction and small swinging in the right and left direction of the walking motion which are obtained by the three-axis acceleration sensor 28.

Furthermore, the autonomous navigation control processing circuit 30 successively accumulates vector data comprising the moving amount and the moving direction obtained as described above into the position data of the reference point supplied from the sub CPU 21, whereby the position data of each point along a moving route is determined and stored in the non-volatile memory 24. Here, the reference point is a point at which positioning of GPS is performed to obtain position data based on GPS. The GPS positioning is intermittently performed at a plurality of points, and thus the reference point is updated every time the GPS positioning is performed. When the reference point is updated, the autonomous navigation control processing circuit 30 successively accumulates the above vector data into the position data at a new reference point to obtain the position data. Accordingly, the update of the reference point prevents error of autonomous navigation positioning from being accumulated for a long time.

the autonomous navigation error correction processing circuit 31 is an arithmetic circuit for assisting the arithmetic processing of the sub CPU 21, and executes error correction on the position data of the autonomous navigation in which error is accumulated. Specifically, on the basis of a command of the sub CPU 21, the following correcting processing is executed on a plurality of position data which are continuously obtained from one reference point (referred to as first reference point) till a next reference point (referred to as second reference point) by the autonomous navigation.

That is, accurate position data at the second reference point is determined by GPS positioning, the value of position data determined by the autonomous navigation at this timing is first shifted so as to be coincident with the accurate position data. Subsequently, with respect to a plurality of position data in the section from the first reference point till the second reference point which have been obtained by the autonomous navigation before the above timing, the data values of the respective position data are continuously shifted so that they are not discontinuous with the previously shifted position data and also the position data at the first reference point is not displaced because the position data at the first reference point has no error. By the error correction as described above, position data at any points between the first and second reference points are continuously shifted so that the error is nullified at the first reference point and the second reference point. Therefore, the position data are corrected to have little error as a whole.

In ROM 12 of the first processor 10 is stored a control program for changing the display content of the display unit 17 on the basis of an input from the external through the operation key 14, driving the imaging unit 16 to take image data, obtaining present position data from the second processor 20 and saving the present position data in association with the image data.

In ROM 22 of the second processor 20 is stored a positioning control processing program for controlling the position measurement based on GPS and autonomous navigation. This positioning control processing program may be stored in ROM 22, or a portable storage medium such as an optical disc or the like which is readable by the sub CPU 21 through a data reading device or a non-volatile memory such as a flash memory or the like. Furthermore, this embodiment is applicable to such a style that such a program is down-loaded into the electronic equipment 1 through a communication line by using carrier waves as a medium.

Next, the positioning control processing executed in the electronic equipment 1 having the above construction will be described.

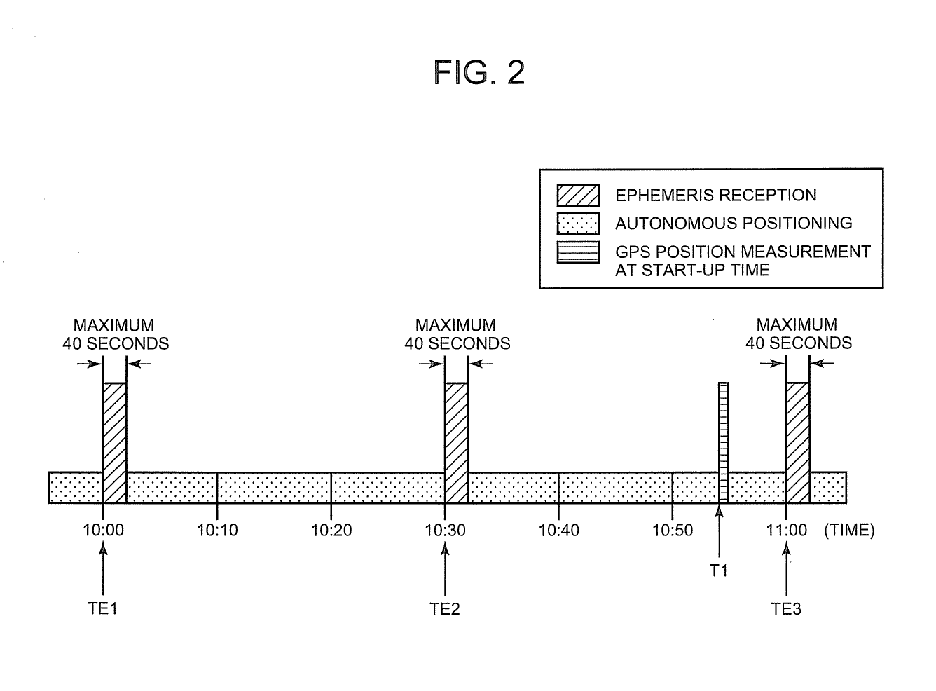

FIG. 2 is a diagram showing an example of the operation of the positioning control processing of the electronic equipment 1. This diagram shows the operation of the positioning control processing when a user walks with carrying the electronic equipment 1 under the state that the power supply key 15 is turned off, and the power supply key is turned on for only a short time at a timing T1 during walking.

As shown in FIG. 2, in the positioning control processing of this embodiment, even under the state that the power supply key 15 is turned off, the second processor 20 operates at all times and the position measurement based on the autonomous navigation is continuously executed when the electronic equipment 1 is not under the stopped state because it is carried or the like.

In the positioning control processing of this embodiment, in any case where the power supply key 15 is turned on or turned off, the processing of receiving ephemeris information is executed every predetermined period (for example, 30 minutes) as indicated by timings TE1 to TE3 of FIG. 2. The ephemeris information is course information for specifying the position of a GPS satellite, and it is information necessary for the positioning processing of GPS. When the ephemeris information is once received and stored, it can be used for several hours to calculate the position of one GPS satellite. Accordingly, by using the ephemeris information stored through the intermittent reception processing, the positioning operation can be executed at short times to obtain position data even when a positioning request is made at any timing.

In the processing of receiving the ephemeris information, positioning codes are received from a plurality of GPS satellites, and thus the positioning operation is also executed on the basis of the reception of the positioning codes to obtain position data. Accordingly, the reception point of the ephemeris information corresponds to a point at which the position measurement based on GPS is executed, and also it is set as a reference point for the positioning processing based on the autonomous navigation.

In the reception processing of the ephemeris information and the positioning operation, for example when the number of GPS satellites whose radio waves can be acquired is limited because the electronic equipment 1 is located at a valley between buildings or the like, there occurs a case where all the processing is not completed within a predetermined processing time (for example, 40 seconds). Accordingly, in such a case, the processing is halfway finished.

The period at which the ephemeris information is received do not need to set to a fixed period, and for example, the reception period may be varied under a predetermined condition by lengthening the period required until next reception when a lot of effective ephemeris information usable for the positioning operation remains or by shortening the period required till next reception when the amount of the ephemeris information is reduced.

The electronic equipment 1 of this embodiment is set so that the operation of turning on the power supply key 15 corresponds to a GPS positioning request. As shown in FIG. 2, when the power supply key 15 is turned on at the timing T1, the sub CPU 21 starts the positioning processing based on GPS and executes the position measurement at short times by using the stored ephemeris information. When the position measurement based on GPS is completed, the measurement result data is stored as position data responded to the positioning request in association with time information in the non-volatile memory 24.

When the power supply key 15 is turned on to start the processing of the position measurement of GPS and then the power supply key 15 is switched to an off-state after an extremely short time, there may occur a case where the positioning processing of GPS has not been complemented during this period.

In a case where effective ephemeris information is not so much held or the number of GPS satellites whose radio waves can be acquired is small and limited at a valley between buildings or the like, the time taken for the positioning processing is longer, and thus there occurs a case where the positioning processing of GPS is not completed within a predetermined processing time (for example, 20 seconds to 60 seconds)

Accordingly, in such a case, the position data calculated based on the autonomous navigation are obtained as the position data responded to the positioning request in place of the position data based on GPS, and this data is stored in the non-volatile memory 24 in association with the time information. By obtaining alternative position data as described above, lack of the position data responded to the positioning request can be avoided even when the positioning processing based on GPS is not properly executed.

Next, an example of the control procedure for implementing the positioning control processing described above will be described on the basis of a flowchart.

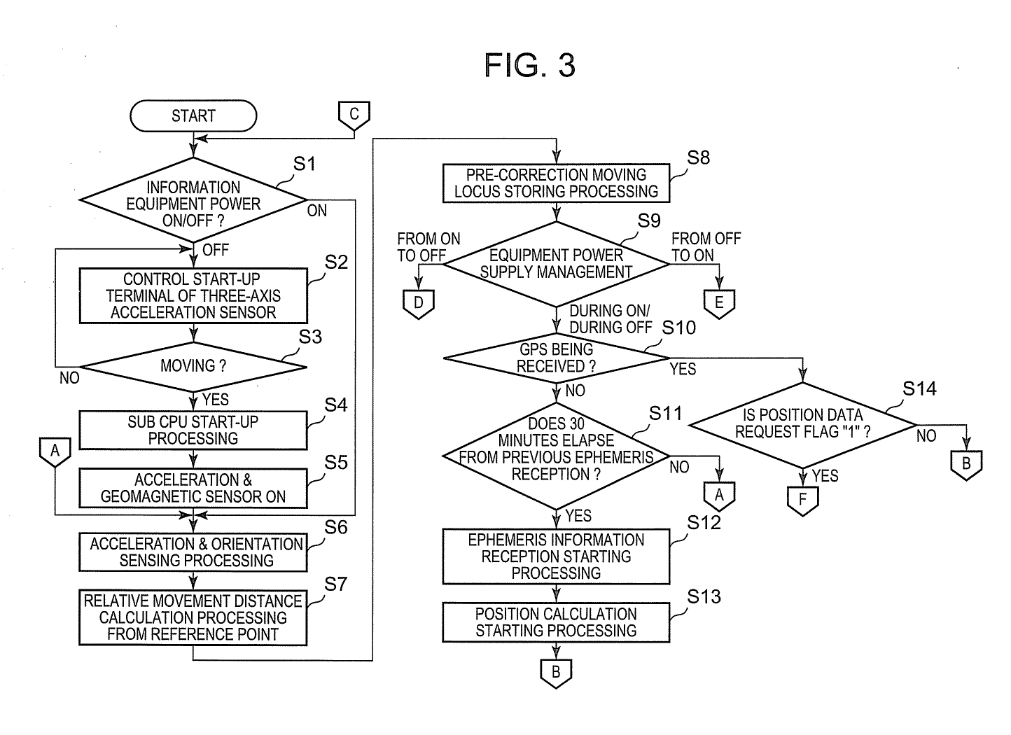

FIGS. 3 to 7 are flowcharts of the positioning control processing executed by the sub CPU 21.

The positioning control processing is started concurrently with power-on of the sub CPU 21 and executed at all times. In this flowchart, the processing of steps S1 to S3 is not the software processing of sub CPU 21, but represents the hardware processing based on an equipment on-flag in a status register for controlling the start-up state of the sub CPU 21 and a start-up control signal output from the three-axis acceleration sensor 28 to the sub CPU 21.

That is, the sub CPU 21 is set to a state under which the sub CPU 21 can be shifted to an exciting state when the equipment on-flag representing the power switching state of the electronic equipment 1 is equal to a value “1” representing power-on and the sub CPU 21 can be shifted to a sleep state when the equipment on-flag is equal to a value “0” representing power-off. Furthermore, when the start-up control signal of the three-axis acceleration sensor 28 is set to an inactive level under the state that the equipment on-flag is set to “0”, the sub CPU 21 is shifted to the sleep state, and when it is set to an active level, the sub CPU 21 is released from the sleep state.

Accordingly, when the power of the electronic equipment 1 (referred to as “information equipment” in FIG. 3) is set to ON on the basis of the judgment of the equipment on-flag (step S1), the sub CPU 21 is under the start-up state, and thus the sub CPU 21 executes the processing from the step S6. On the other hand, when the power of the electronic equipment 1 is turned off, it is judged by the control based on the start-up control signal of the three-axis acceleration sensor 28 (step S2) whether the electronic equipment 1 is under the moving state or the stopped state (step S3). When the start-up control signal is at the inactive level (“NO” in step S3), the sub CPU 21 is kept under the sleep state, and when the start-up control signal of the three-axis acceleration sensor 28 is set to the active level (“Yes” in step S3), the sub CPU 21 is started up, and executes the processing from the step S4.

As a result, when the processing is started from the step S4, the sub CPU 21 first executes the start-up processing thereof (step S4), and then executes the processing of turning on the power of the second processor 20 including the three-axis acceleration sensor 28, the three-axis geomagnetic sensor 29, etc. (step S5). Then, the processing goes to step S6.

When the processing goes to the step S6, the sub CPU 21 first executes the positioning processing based on the autonomous navigation (steps S6 to S8). That is, the sub CPU 21 makes the three-axis acceleration sensor 28 and the three-axis geomagnetic sensor 29 detect the acceleration and the orientation (step S6) and sends the detection data to the autonomous navigation control processing circuit 30 to calculate the present position data (step S7). When the position data are obtained by the autonomous navigation control processing circuit 30, the position data are stored as moving locus data before correction into the non-volatile memory 24 (step S8).

That is, the processing of the steps S6 to S8 described above is repetitively executed on the basis of the loop processing of the steps S6 to S11, etc., whereby the positioning processing based on the autonomous navigation is continuously executed at the back during the period when the sub CPU 21 is started up. That is, these processing constitutes the second measurement control step.

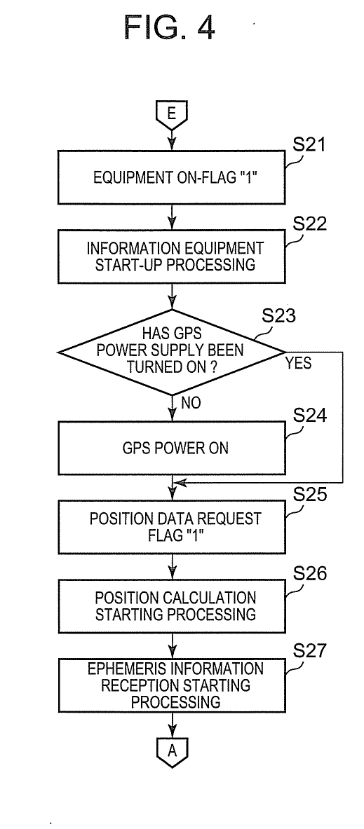

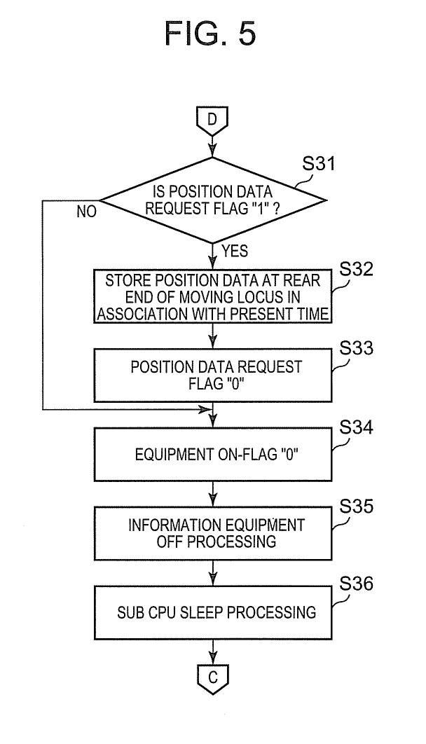

When the positioning processing based on the autonomous navigation is executed, the sub CPU 21 executes the branch processing corresponding to the power supply state of the electronic equipment 1 (step S9). When the power supply is not switched, the processing goes to step S10, when the power supply is switched from OFF to ON, the processing goes to the processing at the power-on time (the steps S21 to S27 of FIG. 4) and when power supply is switched from ON to OFF, the processing goes to the processing at the power-off time (the steps S31 to S36 of FIG. 5).

First, the processing at the power-on time will be first described. When the processing is branched to the processing at the power-on time (the steps S21 to S27 of FIG. 4) in the determination processing of the step S9, the sub CPU 21 first sets the equipment on-flag representing the power supply state of the electronic equipment 1 to “1” (step S21), and then executes the processing corresponding to the start-up of the electronic equipment 1 (referred to as “information equipment”) so that the sub CPU 21 can receive/send commands and information from/to the main CPU 11 (step S22). Furthermore, the sub CPU 21 checks whether the power of the GPS reception circuit 26 has been already turned on (step S23), and when it is turned off, the sub CPU 21 turns on the power (step S24).

Subsequently, the sub CPU 21 sets the position data request flag representing issuance of the positioning request based on the power-on operation to “1” (step S25), makes the GPS reception circuit 26 receive radio waves from the GPS satellite and also starts the arithmetic processing of the position thereof (GPS positioning operation) (step S26: first measurement control step) In this positioning operation, the sub CPU 21 executes the calculation of the position by using the ephemeris information stored in the non-volatile memory 24. Furthermore, the radio waves of the GPS satellite are received by the GPS reception circuit 26. Therefore, in connection with this, a reception start command of ephemeris information is issued to the intermittent reception control circuit 27 (step S27), and reception of the ephemeris information is also started. When these processing is started, the processing returns to step S6.

That is, through the processing of the steps S25 and S26, when the power-on operation is executed, a request of position data (positioning request) is made and the position measurement processing based on GPS is started.

Next, the processing when the power supply key 15 is not switched will be described. When the power supply key 15 of the electronic equipment 1 is kept to be turned on or off and the processing goes to step S10 in the judgment processing of the step S9, the sub CPU 21 first judges whether the GPS reception circuit 26 is operating and is receiving a signal from a GPS satellite (step S10). As a result, when the GPS reception circuit 26 is not under reception, it is determined whether a fixed time (for example, 30 minutes) elapses from the reception of the previous ephemeris information (step S11). When the fixed time does not elapse, the processing returns to the step S6.

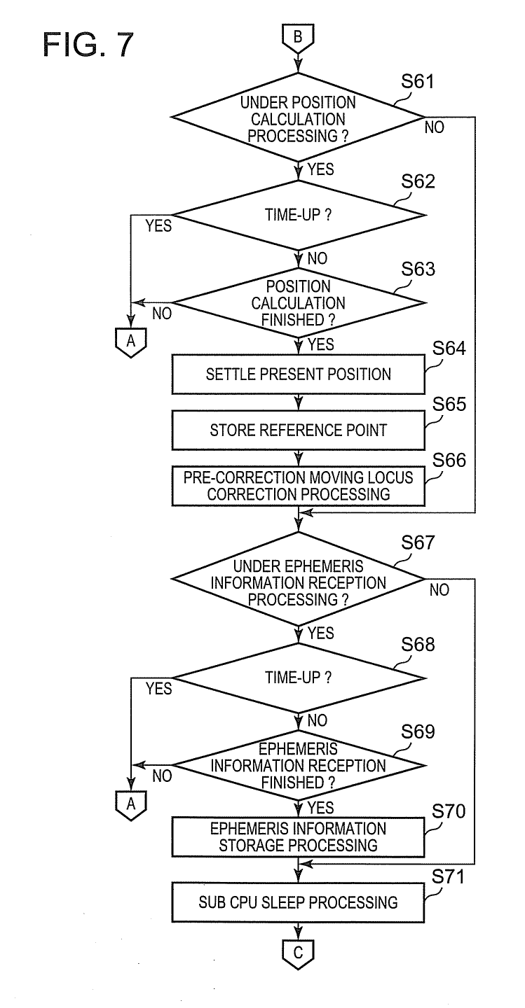

On the other hand, when the time lapse is determined in step S11, issuance of a reception start command of ephemeris information to the intermittent reception control circuit 27 (step S12) and start of the position arithmetic processing (GPS positioning operation) of the sub CPU 21 itself (step S13) are successively performed, and then the processing goes to the control step of the signal reception corresponding to the intermittent reception (steps S61 to S70 of FIG. 7).

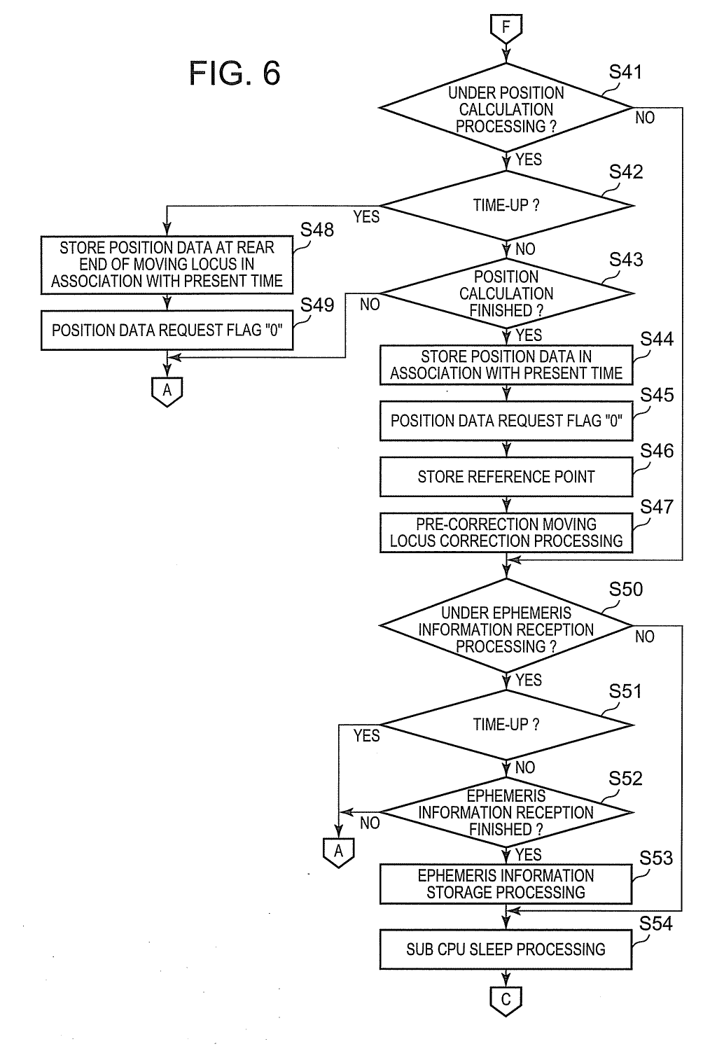

When “under signal reception” is determined in the determination processing of the step S10, the value of a position data request flag in RAM 23 is checked, and it is determined whether the value is equal to “1” (step S14). When the value is equal to “1”, the processing goes to the control step of the signal reception corresponding to the positioning request (the steps S41 to S53 of FIG. 6). When the value is not equal to “1”, the processing goes to the control step of the signal reception corresponding to the intermittent reception of the ephemeris information (the steps S61 to S70 of FIG. 7).

When the position data request flag is equal to “1” and the processing goes to the control step of the signal reception corresponding to the positioning request, the sub CPU 21 first checks whether the present processing status is under position arithmetic processing or not (step S41). When it is under the position arithmetic processing, it is determined whether the processing time exceeds a limited time (for example, a set value in the range from 20 seconds to 60 seconds) (step S42).

Furthermore, when the processing time does not exceed the limited time, it is checked whether the position calculation is finished (step S43). When the position calculation is finished, the calculated position data are successively stored in the storage area corresponding to the positioning request of the non-volatile memory 24 in association with the present time data (step S44: position data obtaining step), and the position data request flag in RAM 23 is set to “0” (step S45). Furthermore, the position data of the reference point of the autonomous navigation positioning is updated (step S46). The position data are sent to the autonomous navigation error correction processing circuit 31 to execute the correction processing of the position data which were previously obtained through the autonomous navigation positioning (step S47). Then, the processing goes to the next processing steps S50 to S54.

On the other hand, when it is determined that the processing time exceeds the limited time in step S42, the calculation of the position based on GPS is halfway stopped, and also the latest position data based on the autonomous navigation stored in the step S8 of FIG. 3 is read out and stored as the position data corresponding to the positioning request into the non-volatile memory 24 in association with the present time data (step S48: position data obtaining step). Then, the position data request flag in RAM 23 is set to “0” (step S49), and then the processing returns to the step S6.

When it is determined that the processing time exceeds the limited time, the processing of the steps S48 and S49 for obtaining the position data based on the autonomous navigation instead is executed, and the calculation of the position based on GPS may be continued without halfway finish. For example, in a case where the limited time of the processing of obtaining the position data corresponding to the positioning request is set to 20 seconds and the limited time of the processing of obtaining the position data entailed by the intermittent reception of ephemeris information is set to 40 seconds, that is, the latter limited time is longer than the former limited time, when no position data is obtained in the GPS positioning processing of 20 seconds, the position data based on the autonomous navigation is alternatively obtained. Furthermore, the GPS positioning processing is continued without change till 40 seconds elapses, and when position data based on GPS is obtained, previously obtained position data based on the autonomous navigation is corrected on the basis of the position data based on GPS, whereby the position data is corrected to more accurate data.

Furthermore, when it is determined in step S41 that the position arithmetic processing is not being executed, the processing directly goes to the next processing steps S50 to S54, and when it is determined in step S43 that the position calculation is not finished, the processing returns to the step S6.

That is, after the positioning request is issued by on-operation of the power supply key 15, the control processing concerning the position calculation described above (steps S41 to S49) is repetitively executed. It is checked whether the position calculation processing overruns the limited time, exceeds the limited time during this period, and when the position calculation is finished, the position data based on GPS is stored as the position data corresponding to the positioning request. On the other hand, when the position calculation is not finished during the limited time, the position data based on the autonomous navigation is alternatively stored as the position data corresponding to the positioning request.

When the processing goes to the next step, the sub CPU 21 first checks whether the present processing status is under ephemeris information receiving processing (step S50). When it is under the receiving processing, the sub CPU 21 determines whether the processing time exceeds the limited time (for example, a set value in the range from 20 seconds to 60 seconds) (step S51). Furthermore, when the processing time does not exceed the limited time, the sub CPU 21 inquires to the intermittent reception control circuit 27 to check whether the reception of the ephemeris information is finished or not (step S52). When the reception is finished, the ephemeris information is stored in the non-volatile memory 24 (step S53), and the processing goes to the next step S54. On the other hand, when it is determined in step S50 that the ephemeris information is not being received, the processing directly goes to the next step S54, and when it is determined in step S51, 52 that the processing time exceeds the limited time or the reception has not yet been finished, the processing returns to the step S6.

When the position calculation processing or the reception of the ephemeris information is finished, the processing goes to the step S54 and the sub CPU 21 executes the processing of shifting to the sleep state. Here, when the power of the electronic equipment 1 is turned off and the start-up control signal of the three-axis acceleration sensor 28 is at the inactive level, the sub CPU 21 shifts to the sleep state, and the power of the second processor 20 is turned off. The processing is shifted to the start-up waiting processing state of the steps S2, S3. On the other hand, when the power of the electronic equipment 1 is turned on or the start-up control signal of the three-axis acceleration sensor 28 is at the active level, the sub CPU 21 does not shift to the sleep state, but continues the processing from the step S6.

After the step S13 of FIG. 3 or when it is determined in steps S10, s14 of FIG. 3 that the GPS signal is being received and the position data request flag is set to “0”, the processing goes to the control step of the signal reception (FIG. 7) corresponding to the intermittent reception of the ephemeris information. The processing of FIG. 7 corresponds to the processing obtained by emitting the processing concerning the positioning request (steps S44, S45, S48, S49) from the control processing of FIG. 6 described above, and the other processing content and processing procedure are substantially the same.

Different points are only a point that the limited time is set to a time different from 40 seconds in the processing of determining whether the processing time exceeds the limited time in steps S62, S68, and a point that when the position operation is finished, the processing of simply settling the present position on the basis of the position data concerned is executed.

Therefore, the detailed description is omitted, however, the intermittent reception of the ephemeris information is started and the processing of FIG. 7 is repetitively executed, whereby it is checked whether the reception of necessary ephemeris information is completed, whether the processing of the position calculation is completed or whether the processing time exceeds the limited time. When the reception is completed or the processing of the position calculation is completed, the corresponding processing is executed.

Next, the processing at the power-off time will be described. When the power supply key 15 is switched from ON to OFF and the processing is branched to the processing at the power-off time (the steps S31 to S36 of FIG. 5) in the determination processing of the step S9, the sub CPU 21 first checks the position data request flag in RAM 23, and determines whether this value is equal to “1” (step S31). As a result, when the value is not equal to “1”, the processing directly jumps to the step S34. However, when the value is equal to “1”, the latest position data out of the position data based on the autonomous navigation stored in the step S8 of FIG. 3 is read out, and this position data is stored in the storage area corresponding to the positioning request of the non-volatile memory 24 in association with the present time data (step S32: position data obtaining step). Then, the position data request flag in RAM 23 is set to “0” (step S33).

That is, in a case where the power supply key 15 is switched to OFF at extremely short times after the power supply key 15 is turned on and a positioning request is issued; therefore the GPS positioning processing is not completed, the position data calculated by the autonomous navigation is alternatively obtained through the steps S31 to S33.

Subsequently, the sub CPU 21 sets the equipment on-flag representing the power supply state of the electronic equipment 1 to “0” (step S34). Subsequently, the sub CPU 21 executes the processing corresponding to the power-off of the electronic equipment 1 (referred to as “information equipment”) such as finishing of the state of communication with the main CPU 11 or the like (step S35), thereby executing the processing of shifting to the sleep state of the sub CPU 21 itself (step S36). When the electronic equipment 1 is under a stationary state and the start-up control signal of the three-axis acceleration sensor 28 is set to the inactive level, the sub CPU 21 shifts to the sleep state, and the power of the second processor 20 is turned off. Then, the processing goes to the start waiting processing state of the steps S2, S3. On the other hand, when the three-axis acceleration sensor 28 detects an acceleration variation and the start-up control signal is at the active level, the sub CPU 21 does not go to the sleep state, but continues the processing from the step S6.

According to the positioning control processing described, the position measurement based on the autonomous navigation as describe with reference to FIG. 2 is continuously executed, and also the reception processing of the ephemeris information is intermittently executed, thereby implementing a state that the position measurement based on GPS can be performed at short times. When the power supply key 15 is turned on and the positioning request is made, the position measurement based on GPS is quickly performed and position data are obtained, or when the position measurement based on GPS is not properly executed, position data based on the autonomous navigation is alternatively obtained.

As described above, according to the electronic equipment 1 of this embodiment and the positioning control method thereof, the position data based on the autonomous navigation is alternatively obtained. Therefore, even when the positioning processing based on GPS which is started in response to a positioning request cannot be properly executed, lack of the position data responded to the positioning request does not occur.

Furthermore, in the electronic equipment 1 of this embodiment, even when the positioning processing based on GPS is not completed during the period from the issuance of the positioning request based on the power-on operation till power-off, the position data based on the autonomous navigation is alternatively obtained. Accordingly, the position data at the power-on time can be left while discriminated from other position data, and further lack of this position data does not occur even when the power is turned off at extremely short times.

In the electronic equipment 1 of this embodiment, when the motion of the equipment is detected in spite of power-off because the equipment is carried or the like, the continuous position measurement based on the autonomous navigation and the intermittent reception processing of ephemeris information are executed. However, when the motion of the equipment is not detected by the three-axis acceleration sensor 28 in power-off, the position measurement based on the autonomous navigation and the intermittent reception of the ephemeris are stopped. Accordingly, the operation when the equipment is perfectly unused is stopped, and thus needless power consumption can be omitted.

The present invention is not limited to the above embodiment, and various alternations may be made. For example, in the above embodiment, the positioning processing using the GPS satellite is applied. However, the positioning processing using a positioning satellite other than GPS may be applied. In the above embodiment, the construction of determining the moving direction and the moving amount of a walker on the basis of the detection of the three-axis acceleration sensor and the three-axis geomagnetic sensor to calculate position data is constructed as the positioning processing based on the autonomous navigation. However, the present invention may be applied to a construction that the moving direction and moving amount of a vehicle may be determined by using a gyro sensor and a velocity sensor for a vehicle to calculate position data.

In the above embodiment, the positioning request is issued by on-operation of the power supply key 15. For example, when a positioning request is issued upon imaging operation, but the positioning processing based on the positioning satellite is not completed within a predetermined time, the position data based on the autonomous navigation may be alternatively obtained. The detailed construction and the detailed method described in the above embodiment may be properly altered without departing from the subject matter of the present invention.

What is claimed is:

1. A positioning device comprising:
a receiver for receiving a signal from a positioning satellite;
first positioning means for performing position measurement on the basis of a signal of the positioning satellite received through the receiver;
second positioning means for measuring a moving direction and a moving amount and accumulating a moving vector comprising the moving direction and the moving amount to perform relative position measurement;
an operating unit for accepting an operation input from an external; and
a measurement controller for making the second positioning means execute position measurement continually and making the first positioning means execute position measurement under a predetermined condition, wherein the measurement controller makes the first positioning means execute the position measurement when a positioning request is made through the operating unit, and the measurement controller obtains positioning result data of the first positioning means as position data responded to the positioning request when position measurement of the first positioning means is performed, and obtains positioning result data of the second positioning means as position data responded to the positioning request when position measurement of the first positioning means is not performed.

2. The positioning device according to claim 1, wherein the operating unit contains a power supply operating unit that turns on/off partial power supply, and the positioning request is generated by a power-on operation of the power supply operating unit.

3. The positioning device according to claim 2, wherein when position measurement is not, executed by the first positioning means from a power-on operation of the power supply operating unit till a next power-off operation, the measurement controller obtains positioning result data of the second positioning means as position data responded to the positioning request.

4. The positioning device according to claim 1, further comprising a motion detector for detecting presence or absence of a motion, wherein the measurement controller makes the second positioning means execute the position measurement continuously during a period when it is determined on the basis of a detection of the motion detector that the positioning device is not under a stationary state, and makes the second positioning means stop the position measurement when it is determined on the basis of a detection of the motion detector that the positioning device is under a stationary state.

5. A positioning method for performing position measurement by using a receiver for receiving a signal from a positioning satellite, first positioning means that can perform position measurement on the basis of a signal of the positioning satellite received through the receiver, and second positioning means that can measure a moving direction and a moving amount and accumulate a moving vector comprising the moving direction and the moving amount to perform relative position measurement comprising:
a first measurement control step for making the first positioning means execute position measurement in response to a positioning request;
a second measurement control step for making the second positioning means execute position measurement continually; and
a position data obtaining step for obtaining measurement result data of the first measurement control step as position data responded to the positioning request when position measurement in the first measurement control step is performed and obtaining measurement result data of the second measurement control step as position data responded to the positioning request when position measurement in the first measurement control step is not performed.

6. A storage medium readable by a computer that controls a receiver for receiving a signal from a positioning satellite, first positioning means that can perform position measurement on the basis of a signal of the positioning satellite received through the receiver, and second positioning means that can measure a moving direction and a moving amount and accumulate a moving vector comprising the moving direction and the moving amount to perform relative position measurement, the storage medium storing a program making the computer execute:
a first measurement control function of making the first positioning means execute position measurement in response to a positioning request;
a second measurement control function of making the second positioning means execute position measurement continually; and
a position data obtaining function of obtaining measurement result data of the first measurement control function as position data responded to the positioning request when position measurement in the first measurement control function is performed and obtaining measurement result data of the second measurement control function as position data responded to the positioning request when position measurement in the first measurement control function is not performed.
